(19) United States
(12) Patent Application Publication
(10) Pub. No.: US 2021/0165676 A1
(43) Pub. Date: Jun. 3, 2021

(54) INFORMATION PROCESSING DEVICE, MANAGEMENT PROGRAM, MANAGEMENT METHOD, AND INFORMATION PROCESSING SYSTEM

(71) Applicant: OMRON Corporation, Kyoto-shi (JP)

(72) Inventor: Tetsuo YOSHIKAWA, Yokohama-shi (JP)

(73) Assignee: OMRON Corporation, Kyoto-shi (JP)

(21) Appl. No.: 17/069,893

(22) Filed: Oct. 14, 2020

(30) Foreign Application Priority Data
Nov. 29, 2019 (JP) 2019-216983

(51) Int. Cl. G06F 9/455; G06F 9/48

(52) U.S. Cl. CPC G06F 9/45558; G06F 2009/45575; G06F 2009/45562; G06F 9/485

(57) ABSTRACT

A technique is provided for performing shutdown of a virtualization system. A control unit of a server may be configured with instructions to perform operations comprising operation as a first management unit that manages shutdown of a plurality of virtual machines that operate on a hypervisor, and a second management unit that, when all of the virtual machines are shut down, shuts down the server, and the first management unit, upon acquiring information indicating that shutdown of a virtual machine is completed, executes shutdown of another virtual machine.

### CROSS-REFERENCES TO RELATED APPLICATIONS

This application claims the benefit of priority to Japanese Patent Application No. 2019-216983 filed Nov. 29, 2019, the entire contents of which are incorporated herein by reference.

### FIELD

The disclosure relates to an information processing device, a management program, a management method, and an information processing system.

### BACKGROUND

A virtualization system is known as are known techniques for virtualization. For example, JP 2017-187992A discloses that a virtual environment can be realized in which a plurality of Operating Systems (OSs) are executable independently to each other using a shared hardware resource, in a control device including at least one processor.

JP 2017-187992A, JP 5664004B, JP 6029165B, and JP 5206750B are examples of background art.

However, when a virtualization system is shut down, next processing (such as shutdown of another guest OS) is performed following a set time schedule, without confirming whether or not a guest OS has been shut down (see JP 5664004B and JP 6029165B, for example).

Therefore, in the verification at the time of system construction, there is a problem in that it is not possible to confirm whether or not a guest OS has been shut down, and the next processing cannot be performed until a set time has elapsed, and therefore time is wasted in the verification. Also, there is a problem in that if a longer time is taken to shut down a guest OS than estimated, the guest OS may not properly be shut down.

Also, the shutdown of a guest OS is regarded as completed when a set time has elapsed, and the coupling between a virtual OS (hypervisor), a virtual storage, and the like is released.

Note that, in JP 5206750B, a configuration in which a power supply device supplies power to a virtual host computer via a tap is disclosed.

### SUMMARY

In accordance with one or more aspects, a technique may be provided for appropriately performing the shutdown of a virtualization system.

In order to address the above problem, an information processing device according to one aspect may include a control unit configured with instructions to perform operations comprising operations as: a first management unit configured to manage shutdown of a plurality of guest OSs that operate on a virtual OS; and a second management unit configured to shut down the information processing device when all of the plurality of guest OSs have been shut down by the first management unit, and the first management unit, upon acquiring information indicating that shutdown of one of the plurality of guest OSs is completed, executes shutdown of a guest OS other than the one guest OS.

According to the above-described configuration, when the shutdown of one of a plurality of guest OSs that operates on a virtual OS is completed, shutdown of another guest OS is executed, and when all of the plurality of guest OSs are shut down, the information processing device is shut down, and as a result, the virtualization system can be appropriately shut down.

In the information processing device according to one or more aspects, the control unit may include a third management unit that monitors the statuses of the plurality of guest OSs and control the plurality of guest OSs, and the first management unit may acquire status information of each of the plurality of guest OSs via the third management unit, and execute shutdown of the plurality of guest OSs via the third management unit.

According to the above-described configuration, the shutdown of the plurality of guest OSs is executed by acquiring status information of each of the plurality of guest OSs, and as a result, the plurality of guest OSs can be appropriately shut down.

In the information processing device according to one or more aspects, the second management unit, when all of the plurality of guest OSs are shut down by the first management unit, may shut down the information processing device via a control device that controls the information processing device and an uninterruptible power supply device connected to the information processing device.

According to the above-described configuration, as a result of interposing a control device that controls the information processing device and the uninterruptible power supply device connected to the information processing device, the information processing device can be appropriately shut down.

The information processing device according to one or more aspects may have a test mode in which the plurality of guest OSs are shut down following a predetermined order.

According to the above-described configuration, as a result of providing a test mode in which the plurality of guest OSs are shut down following a predetermined order, shutdown of guest OSs in a various order can be tried.

The information processing device according to one or more aspects may further include a display control unit configured to generate screen data for displaying a shutdown time of each guest OS in the test mode.

According to the above-described configuration, the shutdown time of each guest OS in the test mode is displayed, and as a result, the appropriate order of shutdown of the guest OSs can be examined.

In the information processing device according to one or more aspects, the screen data may further include: an accumulated time of the shutdown time of each guest OS; an item indicating whether or not each guest OS has been successfully shut down; and a time limit of the accumulated time.

According to the above-described configuration, an accumulated time of the shutdown time of each guest OS, an item indicating whether or not each guest OS has been successfully shut down, and a time limit of the accumulated time, in the test mode, are further displayed, and as a result, the more appropriate order of shutdown of the guest OSs can be examined.

A management program according to one or more aspects may be executed on a virtual OS to be executed on at least one information processing device, the management program causes the at least one information processing device to carry out the steps of: a first management step of managing shutdown of a plurality of guest OSs that operate on the virtual OS; and a second management step of shutting down the at least one information processing device when all of the plurality of guest OSs have been shut down by the first management step, wherein, in the first management step, when information indicating that shutdown of one of the plurality of guest OSs is completed is acquired, shutdown of a guest OS other than the one guest OS is executed.

A management method according to one or more aspects may be executed on at least one information processing device, the management method causes the at least one information processing device to carry out the steps of: a first management step of managing shutdown of a plurality of guest OSs that operate on the virtual OS; and a second management step of shutting down the at least one information processing device when all of the plurality of guest OSs have been shut down by the first management step, wherein, in the first management step, when information indicating that shutdown of one of the plurality of guest OSs is completed is acquired, shutdown of a guest OS other than the one guest OS is executed.

An information processing system according to one or more aspects may include an information processing device, an uninterruptible power supply device, and a control device, wherein the information processing device includes a control unit, the control unit includes: a first management unit configured to manage shutdown of a plurality of guest OSs that operate on a virtual OS; and a second management unit configured to shut down the information processing device when all of the plurality of guest OSs have been shut down by the first management unit, the first management unit, upon acquiring information indicating that shutdown of one of the plurality of guest OSs is completed, executes shutdown of a guest OS other than the one guest OS, the uninterruptible power supply device is connected to the information processing device, and the control device controls the information processing device and the uninterruptible power supply device.

An information processing system according to one or more aspects may include a plurality of information processing devices, wherein the plurality of information processing devices each includes a control unit, the control unit of at least one information processing device includes: a first management unit configured to manage shutdown of a plurality of guest OSs that operates on a virtual OS; and a second management unit configured to shut down the information processing devices when all of the plurality of guest OSs have been shut down by the first management unit, and the first management unit, upon acquiring information indicating that shutdown of one of the plurality of guest OSs is completed, executes shutdown of a guest OS other than the one guest OS.

The information processing device according to aspects of the present invention may be realized using a computer, and in this case, a control program for an information processing device that realizes the information processing device on a computer by causing the computer to operate as the units (software elements) included in the information processing device, and a computer-readable storage medium storing the control program also fall within the scope of the present invention.

According to one or more aspects, the shutdown of a virtualization system can be appropriately performed.

### BRIEF DESCRIPTION OF THE DRAWINGS

FIG. 1 is a diagram illustrating a configuration of an information processing system according to one or more embodiments including Embodiment 1.

FIG. 2 is a diagram illustrating an outline of virtual software according to one or more embodiments including Embodiment 1.

FIG. 3 is a diagram illustrating a detailed configuration of virtual software and a configuration of a periphery according to one or more embodiments including Embodiment 1.

FIG. 4 is a block diagram illustrating a configuration of a UPS according to one or more embodiments including Embodiment 1.

FIG. 5 is a block diagram illustrating a configuration of a network card according to one or more embodiments including Embodiment 1.

FIG. 6 is a flowchart illustrating processing of a server according to one or more embodiments including Embodiment 1.

FIG. 7 is a flowchart illustrating processing of a network card according to one or more embodiments including Embodiment 1.

FIG. 8 is a diagram illustrating a display screen of a node list according to one or more embodiments including Embodiment 2.

FIG. 9 is a diagram illustrating a screen for displaying information including a shutdown time of each virtual machine in a stoppage test according to one or more embodiments including Embodiment 2.

FIG. 10 is a diagram illustrating a screen for setting a timeout time of each node according to one or more embodiments including Embodiment 2.

FIG. 11 is a diagram illustrating a screen for executing a startup test according to one or more embodiments including Embodiment 2.

FIG. 12 is a diagram illustrating a screen for setting a startup priority according to one or more embodiments including Embodiment 2.

FIG. 13 is a diagram illustrating a setting screen regarding a UPS according to one or more embodiments including Embodiment 2.

FIG. 14 is a diagram illustrating a setting screen regarding a management software according to one or more embodiments including Embodiment 2.

FIG. 15 is a diagram illustrating a script management screen according to one or more embodiments including Embodiment 2.

FIG. 16 is a diagram illustrating a basic setting screen according to one or more embodiments including Embodiment 2.

### DETAILED DESCRIPTION

### Embodiment 1

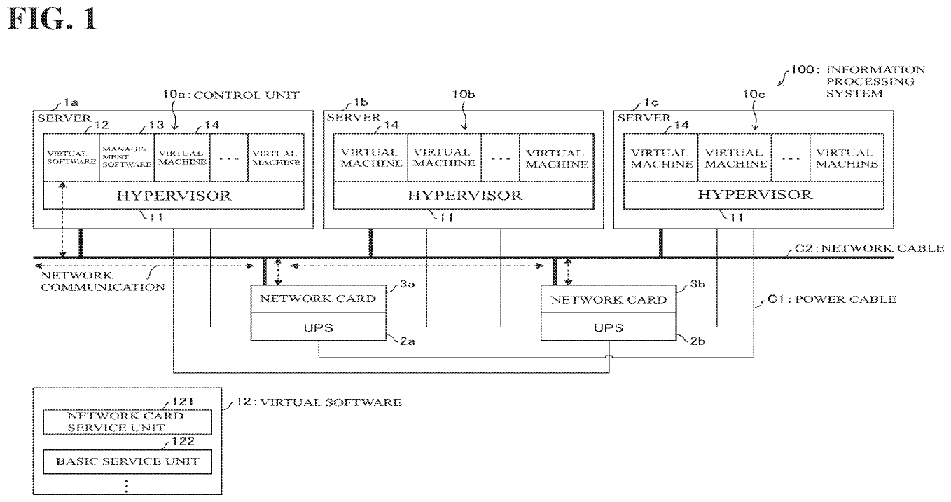

Hereinafter, one or more embodiments according to one or more aspects of the present invention (hereinafter, also denoted as the “present embodiment”) will be described based on FIG. 1 to FIG. 7. Note that the same or corresponding portions are assigned the same reference numerals in the drawings, and duplicate descriptions thereof will be omitted. The present embodiment will be described taking an information processing system 100 as a representative example of a virtualization system, for example. In order to facilitate the understanding of a server 1 according to one or more aspects, an outline of the information processing system 100 will first be described with reference to FIG. 1.

### 1. APPLICATION EXAMPLE

### Configuration of Information Processing System 100

FIG. 1 is a diagram illustrating a configuration of the information processing system 100 according to the present embodiment. As shown in FIG. 1, the information processing system 100 may be a virtualization system that includes the servers 1, Uninterruptible Power Supplies (UPSs) 2, and network cards 3.

The servers 1 may be information processing devices, and, while three servers 1a, 1b, and 1c are shown in FIG. 1, the number of servers is not specifically limited. The UPSs 2 may be uninterruptible power supply devices, and, while two UPSs 2a and 2b are shown in FIG. 1, the number of UPSs 2 is not specifically limited. The network cards 3 may be control devices for controlling the servers 1 and the UPSs 2, and, while two network cards 3a and 3b are shown in FIG. 1, the number of network cards is not specifically limited.

The servers 1a, 1b, and 1c may be connected to the UPSs 2a and 2b through power cables C1, and are supplied with power therefrom. The servers 1a, 1b, and 1c may be connected through a network cable C2 so as to be able to communicate to each other. Also, the servers 1a, 1b, and 1c may be connected to the network cards 3a and 3b through the network cable C2 so as to be able to perform communication. The network card 3a may be inserted into a slot in a back side of the UPS 2a. The network card 3b may be inserted into a slot in a back side of the UPS 2b.

### 2. EXEMPLARY CONFIGURATION

### Configuration of Server 1

As shown in FIG. 1, the server 1a may include a control unit 10a, and may include a hypervisor 11, virtual software 12, management software 13, and virtual machines 14, as the software to be executed by the control unit 10a. The servers 1b and 1c respectively may include control units 10b and 10c, and each of the servers 1b and 1c may include a hypervisor 11 and virtual machines 14 that may be software programs to be executed by the control units 10b and 10c. Note that the control unit 10a of the server 1a may also be configured so as not to include the virtual machines 14.

The hypervisor 11 may be a virtual OS that integrally manages other pieces of software in each server, and may be AHV of Nutanix (registered trademark), ESXi of VMware (registered trademark), or the like. The virtual software 12 may be software for controlling shutdown of the servers 1. The management software 13 may be software for monitoring the states of virtual machines 14 by communicating with the virtual machines 14 of each server, and may be Prism of Nutanix, vCSA of VMware, or the like. The virtual machine 14 may be a guest OS, and may be Linux (registered trademark), Windows (registered trademark), or the like.

The virtual software 12, the management software 13, and the virtual machines 14 may operate under the management of the hypervisor 11. The virtual software 12 may acquire the state of a virtual machine 14 using an API (Application Programming Interface) of the management software 13, and may give an instruction to shut down the virtual machine 14.

### Configuration of Virtual Software 12

As shown in FIG. 1, the control unit 10a may include, as the virtual software 12, a basic service unit (first management unit) 122 that manages shutdown of a plurality of virtual machines 14 that operates on the hypervisor 11, and a network card service unit (second management unit) 121 that shuts down the server la when all of the plurality of virtual machines 14 are shut down by the basic service unit 122. The basic service unit 122, upon acquiring information indicating that the shutdown of the plurality of virtual machines 14 is completed, may execute shutdown of another virtual machine 14.

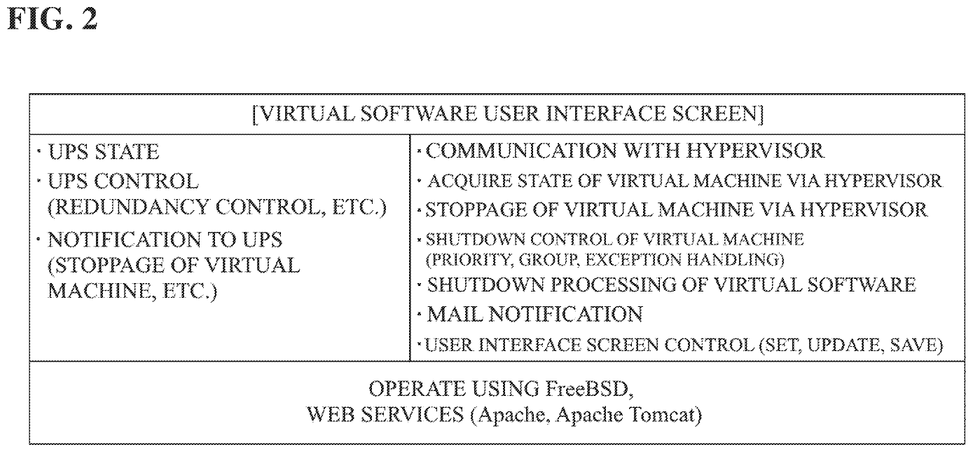

FIG. 2 is a diagram illustrating an outline of the virtual software 12 according to the present embodiment. The virtual software 12 generates a user interface screen, and displays the user interface screen on a display. Items as shown in FIG. 2 are displayed on the user interface screen, and a user can refer to the states. That is, on the user interface screen, items relating to the states of the UPSs 2, control of the UPSs 2 (such as redundancy control), notifications to the UPSs 2 (such as stoppage of a virtual machine), communication with the hypervisors 11, the states of the virtual machines 14 via the hypervisors 11, stoppages of the virtual machines 14 via the hypervisors 11, shutdown control (priority, group, exception handling) of the virtual machine 14, shutdown processing of the virtual software 12, mail notifications, and user interface screen control (setting, updating, saving), are displayed, for example.

Note that the virtual software 12 operates using Free BSD, Web services (Apache, Apache Tomcat), or the like.

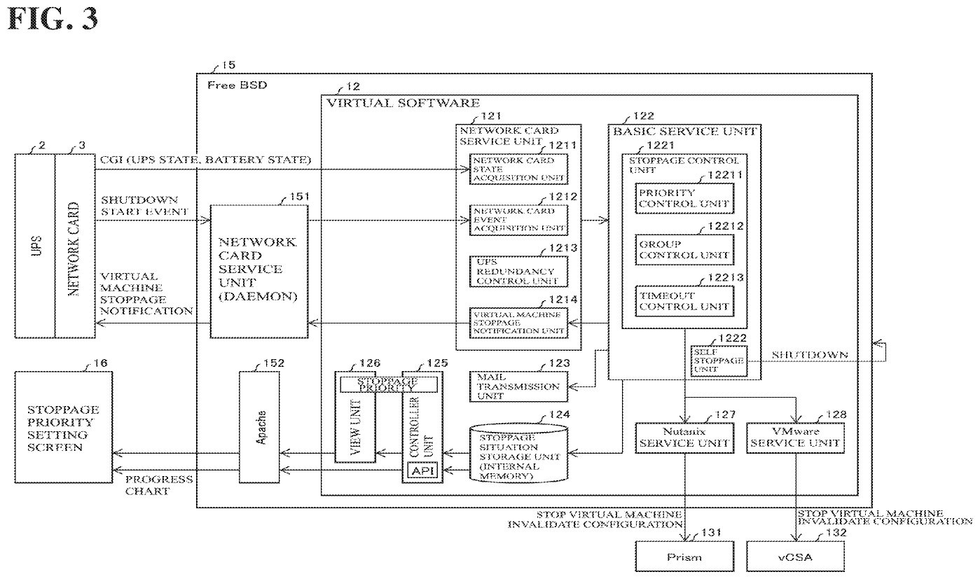

FIG. 3 is a diagram illustrating a detailed configuration of the virtual software 12 and a configuration of a periphery according to the present embodiment. As shown in FIG. 3, the virtual software 12, a network card service unit (daemon) 151, and Apache 152 may operate on Free BSD 15.

The virtual software 12 may include the network card service unit 121, the basic service unit 122, a mail transmission unit 123, a stoppage situation storage unit 124, a controller unit 125, a view unit 126, a Nutanix service unit 127, and a VMware service unit 128.

The network card service unit 121 may communicate with a network card 3. The network card service unit 121 may include a network card state acquisition unit 1211, a network card event acquisition unit 1212, a UPS redundancy control unit 1213, and a virtual machine stoppage notification unit 1214.

The network card state acquisition unit 1211 may acquire the state of a UPS 2 and the battery condition from the network card 3 via a CGI (Common Gateway Interface). The network card event acquisition unit 1212 may acquire a shutdown start event from the network card 3 via the network card service unit (daemon) 151. The UPS redundancy control unit 1213 may control the redundancy of the UPS 2 to which the server 1 is connected. The virtual machine stoppage notification unit 1214 may accept a notification (virtual machine stop notification) indicating that a virtual machine 14 has stopped from the basic service unit 122. Also, the virtual machine stoppage notification unit 1214 may transmit a virtual machine stoppage notification to the network card 3 via the network card service unit (daemon) 151.

The basic service unit 122 may include a stoppage control unit 1221 and a self stoppage unit 1222. The stoppage control unit 1221 may include a priority control unit 12211, a group control unit 12212, and a timeout control unit 12213. The stoppage control unit 1221 may instruct Prism 131, which is one program of the management software 13, to stop a virtual machine 14 and invalidate the virtualization configuration via the Nutanix service unit 127. Also, the stoppage control unit 1221 may instruct vCSA 132, which is one program of the management software 13, to stop a virtual machine 14 and invalidate the virtualization configuration via the VMware service unit 128.

The self stoppage unit 1222 may shut down the Free BSD 15.

The mail transmission unit 123 may acquire the stoppage situations of the virtual machines 14 from the basic service unit 122 and may transmit a mail including the stoppage situations of the virtual machines 14 to the user, as needed. The stoppage situation storage unit 124 may acquire the stoppage situations of the virtual machines 14 from the basic service unit 122 and may store the stoppage situations. The controller unit 125 may acquire the stoppage situations of the virtual machines 14 from the stoppage situation storage unit 124, and may display a progress chart in a stoppage priority setting screen 16 through the view unit 126 and the Apache 152, or through the Apache 152.

### Virtual Software 12 and Management Software 13

The management software (third management unit) 13 of the control unit 10a may monitor the statuses of the plurality of virtual machines 14, and may control the plurality of virtual machines 14. The basic service unit 122 of the virtual software 12 may acquire the status information of each of the plurality of virtual machines 14 via the management software 13, and may execute shutdown of the plurality of virtual machines 14 via the management software 13.

Also, the network card service unit 121 of the virtual software 12 may shut down the servers 1 via the network cards 3 that controls the servers 1 and the UPSs 2 that are connected to the servers 1, when all of the plurality of virtual machines 14 are shut down by the basic service unit 122.

### Configuration of UPS 2

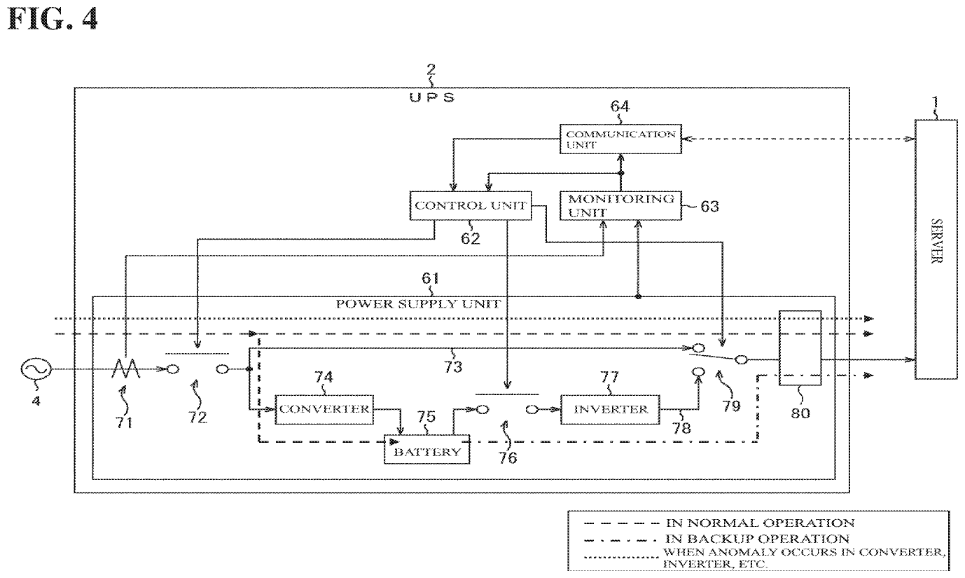

FIG. 4 is a block diagram illustrating a configuration of the UPS 2 according to the present embodiment. As shown in FIG. 4, the UPS 2 may include a power supply unit 61, a control unit 62, a monitoring unit 63, and a communication unit 64.

When the power from the commercial power supply 4 is normal, the power supply unit 61 may receive power supplied from the commercial power supply 4 and supplies the power to the servers 1. Also, when the power from the commercial power supply 4 is anomalous, or power is not supplied, the power supply unit 61 may supply power to the servers 1 from the internal battery 75. The power supply unit 61 may switch the power supply (commercial power supply 4 or battery 75), which serves as a power feeding source to the servers 1, in response to the instruction from the control unit 62.

The control unit 62 may control the opening/closing of an input relay 72 and an output relay 76, and switching of an output switch 79, of the power supply unit 61, in response to the instructions from the monitoring unit 63 and the communication unit 64. The monitoring unit 63 may monitor the situation of a noise filter 71 of the power supply unit 61, and may transmit a monitoring result indicating whether or not the power from the commercial power supply 4 is normal to the control unit 62 and the communication unit 64. The communication unit 64 may transmit the monitoring result from the monitoring unit 63 to the servers 1. Also, the communication unit 64 may make an instruction regarding the switching of the power supply to the control unit 62 in response to an instruction from the servers 1.

### Configuration of Power Supply Unit 61

As shown in FIG. 4, the power supply unit 61 may include the noise filter 71, the input relay 72, a power line 73, a converter 74, the battery 75, the output relay 76, an inverter 77, a power line 78, the output switch 79, and a noise filter 80.

In a normal operation, the input relay 72 is closed, the output relay 76 is open, and the output switch 79 is switched to the power line 73 side, by the control of the control unit 62. In the normal operation, the power from the commercial power supply 4 may be supplied to the servers 1 via the noise filter 71, the input relay 72, the power line 73, the output switch 79, and the noise filter 80. Also, the battery 75 may be charged by the power from the commercial power supply 4 via the noise filter 71, the input relay 72, and the converter 74.

In a backup operation, the input relay 72 is open, the output relay 76 is closed, and the output switch 79 is switched to the power line 78 side, by the control of the control unit 62. In the backup operation, the power from the battery 75 may be supplied to the servers 1 via the output relay 76, the inverter 77, the power line 78, the output switch 79, and the noise filter 80. Note that the power from the commercial power supply 4 is not supplied to the servers 1.

When an anomaly occurs in the converter 74, the inverter 77, or other components of the power supply unit 61, the input relay 72 is closed, the output relay 76 is opened, and the output switch 79 is switched to the power line 73 side, by the control of the control unit 62. In the case of an anomaly, the power from the commercial power supply 4 may be supplied to the servers 1 via the noise filter 71, the input relay 72, the power line 73, the output switch 79, and the noise filter 80. Note that the battery 75 is not charged by the power from the commercial power supply 4.

### Configuration of Network Card 3

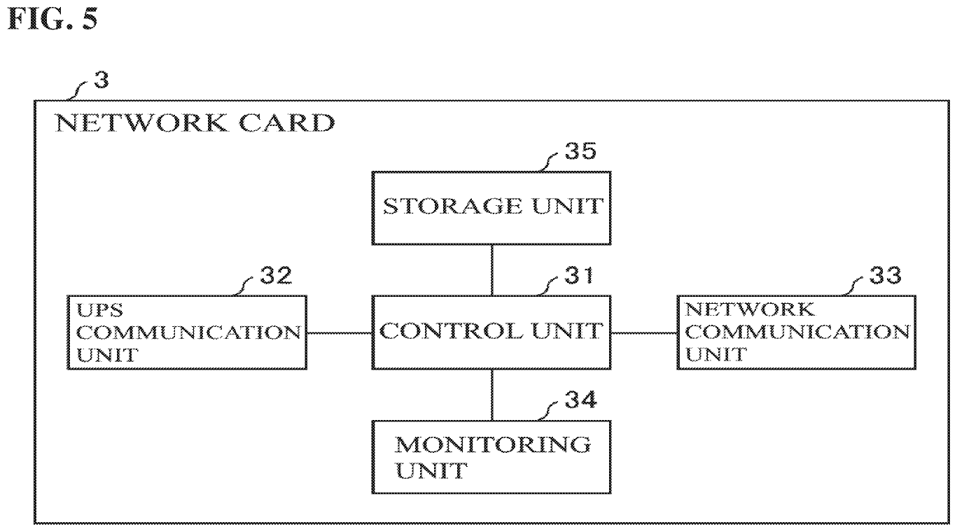

FIG. 5 is a block diagram illustrating a configuration of the network card 3 according to the present embodiment. As shown in FIG. 5, the network card 3 may include a control unit 31, a UPS communication unit 32, a network communication unit 33, a monitoring unit 34, and a storage unit 35. The control unit 31 may control the operations of the entire network card 3. The UPS communication unit 32 may communicate with a UPS 2 via the slot of the UPS 2. The network communication unit 33 may communicate with the servers 1 through the network cable C2, and is a network USB, for example. The monitoring unit 34 may perform time monitoring when shutdown processing is performed. The storage unit 35 may store and read out data in response to the instruction from the control unit 31, and is an HDD, an SSD, or the like.

### Processing of Server 1

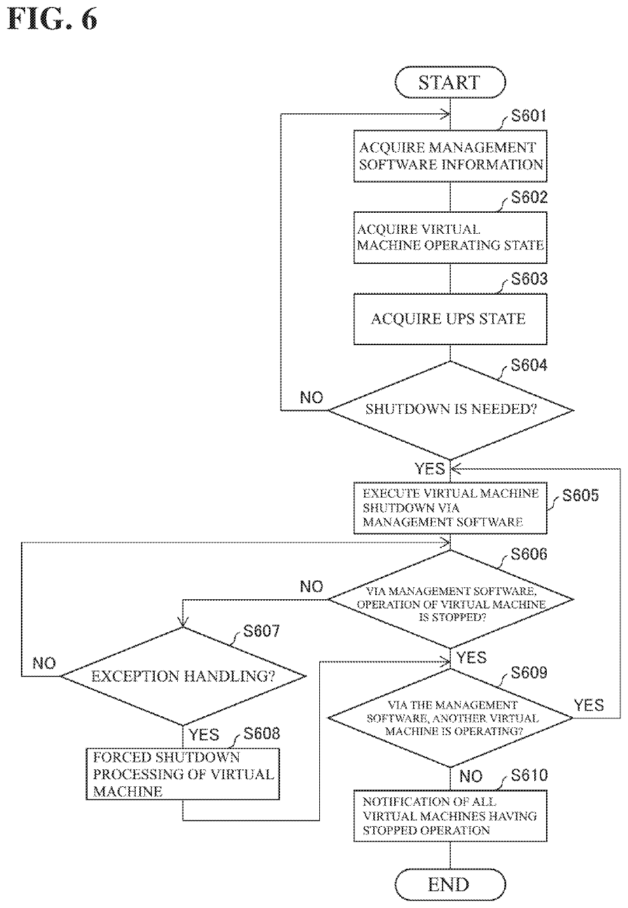

FIG. 6 is a flowchart illustrating processing of the server 1 according to the present embodiment. FIG. 6 shows the processing of the virtual software 12 of the control unit 10a of the server 1a. In the following, the processing of the virtual software 12 will be described following FIG. 6.

### Step S601

In the server 1a, the virtual software 12 may acquire information regarding the management software 13 (e.g., information regarding the API).

### Step S602

The virtual software 12 may acquire the operating states of the virtual machines 14 (operating or not) from the API of the management software 13. In this case, the management software 13 may acquire the operating states of the virtual machines 14 in the server 1a, and may acquire the operating states of the virtual machines 14 in the servers 1b and 1c via the network cable C2. Also, the management software 13 may pass the acquired operating states of the virtual machines 14 to the virtual software 12.

### Step S603

The virtual software 12 may acquire the states of the UPSs 2a and 2b through the API of the management software 13. In this case, the management software 13 may instruct the network cards 3a and 3b to respectively report the states of the UPSs 2a and 2b via the network cable C2. Also, the management software 13 may pass the acquired states of the UPSs 2a and 2b to the virtual software 12.

### Step S604

The virtual software 12 may determine whether or not shutdown is needed by referring to the operating states of the virtual machines 14 acquired in step S602, and the states of the UPSs 2a and 2b acquired in step S603. For example, it may be determined that the shutdown is needed if an operating virtual machine 14 is present and both of the UPSs 2a and 2b are performing the backup operation.

If the shutdown is needed (YES in step S604), the virtual software 12 executes the processing in step S605. If the shutdown is not needed (NO in step S604), the virtual software 12 again executes the processing in step S601.

### Step S605: First Management Step

The virtual software 12 may execute shutdown of one virtual machine 14 that is operating via the management software 13 (that is, using the API of the management software 13).

### Step S606

The virtual software 12 may confirm whether or not the operation of the virtual machine 14 regarding which shutdown was executed has stopped via the management software 13. If the operation of the virtual machine 14 has stopped (YES in step S606), the virtual software 12 executes the determination in step S609. If the operation of the virtual machine 14 has not stopped (NO in step S606), the virtual software 12 executes the determination in step S607.

### Step S607

The virtual software 12 may determine whether or not exception handling (e.g., time-out monitoring processing) is to be performed. If exception handling is to be performed (YES in step S607), the virtual software 12 executes the determination in step S608. If exception handling is not to be performed (NO in step S607), the virtual software 12 again executes the determination in step S606.

### Step S608

The virtual software 12 may execute forced shutdown processing of the virtual machine 14 via the management software 13. Also, the virtual software 12 may execute the determination in step S609.

### Step S609

The virtual software 12 may determine whether or not another virtual machine 14 is operating via the management software 13. If another virtual machine 14 is operating (YES in step S609), the virtual software 12 again executes the processing in step S605. If no other virtual machine 14 is operating (NO in step S609), the virtual software 12 executes the processing in step S610.

### Step S610: Second Management Step

The virtual software 12 may notify the network cards 3a and 3b that all of the virtual machines have stopped operation via the management software 13 and the shutdown of the servers 1 may be performed.

### Processing of Network Card 3

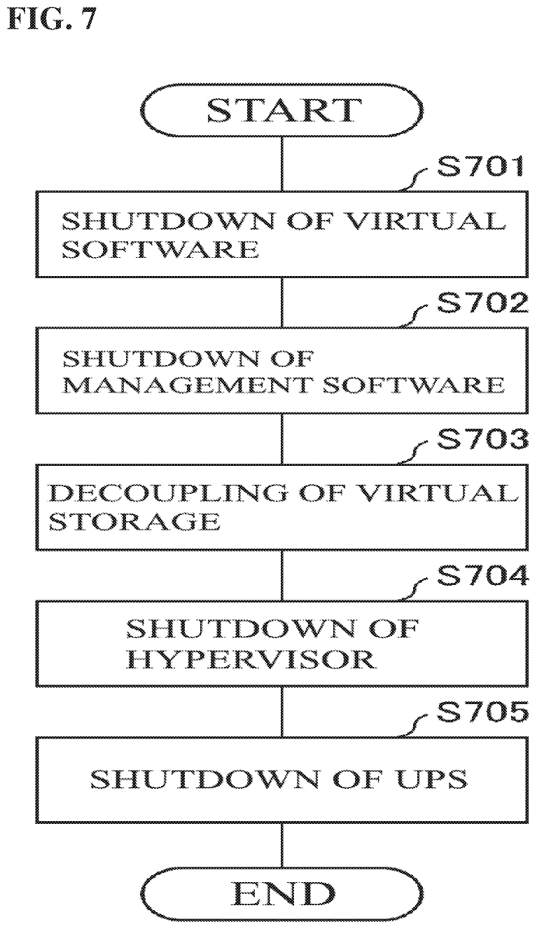

FIG. 7 is a flowchart illustrating processing of the network card 3 according to the present embodiment. In the following, the processing of the network card 3 will be described following FIG. 7. This processing may be executed by the control unit 31 when the network communication unit 33 of the network card 3 has received a notification saying that all of the virtual machines have stopped operation from the virtual software 12.

### Step S701

The control unit 31 of the network card 3 may execute the shutdown of the virtual software 12 via the network communication unit 33 and the network cable C2.

### Step S702

The control unit 31 may execute the shutdown of the management software 13 via the network communication unit 33 and the network cable C2.

### Step S703

The control unit 31 may decouple a virtual storage via the network communication unit 33 and the network cable C2. The virtual storage may be a virtual storage device that is constituted by (logically coupling) a plurality of physical storage devices (such as an HDD (Hard Disk Drive) and an SSD (Solid State Drive)) in at least one server 1. As a result of releasing the coupling of the virtual storage, each physical storage device can be powered off.

Note that the physical storage device that constitutes the virtual storage may not be incorporated in or connected to the servers 1, and may be a NAS (Network Attached Storage) that is directly connected to the network cable C2 and is shared by the plurality of servers 1 through the network cable C2, or may also be constituted by a storage device controlled by a server 1 and a NAS.

### Step S704

The control unit 31 may execute shutdown of the hypervisor 11 via the network communication unit 33 and the network cable C2.

### Step S705

The control unit 31 may execute shutdown of the UPS 2 via the UPS communication unit 32.

### Effects of Embodiment 1

According to the present embodiment, as a result of adopting a method in which, instead of performing next processing at the set time, the next processing is performed after assessing the shutdown states of the virtual machines 14, the shutdown of the information processing system 100, which is a virtualization system, can be appropriately performed. Also, if the next processing cannot be executed due to some factor, the next processing is performed after forcibly performing shutdown by timeout processing, and as a result, the information processing system 100 can be shut down. Moreover, as a result of notifying the network card 3 of the fact that all of the virtual machines 14 are shut down, immediate scripts for shutting down the hypervisor 11, which is a virtual OS, decoupling the virtual storage, and the like can be executed.

### Embodiment 2

Embodiment 2 will be described in the following section. Note that, for the convenience of description, structural elements having the same functions as structural elements described in Embodiment 1 are given the same reference signs, and duplicate descriptions thereof will be omitted.

In the present embodiment, the screen that is managed by the virtual software 12 and is to be displayed in a display of the server 1 or a remote terminal (not illustrated) will be described.

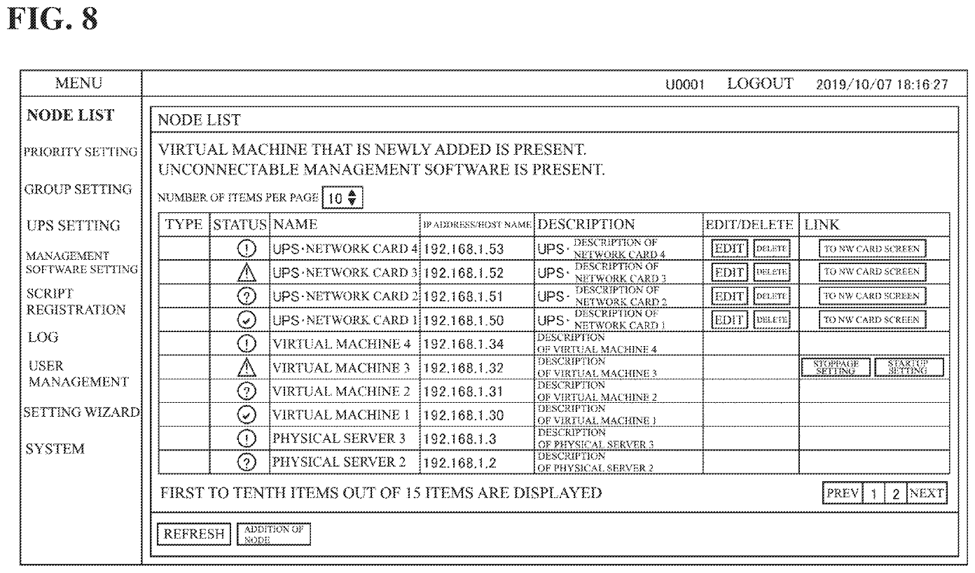

FIG. 8 is a diagram illustrating a display screen of a node list according to the present embodiment. As shown in FIG. 8, the node list shows the states of the servers 1, the UPSs 2, the network cards 3, the virtual machines 14, and the like.

The server 1 may have a test mode in which the plurality of virtual machines 14 (e.g., guest OSs) are shut down following a predetermined order. Upon receiving an instruction to start the test mode that may be given by a user operation, the control unit 10 of the server 1 may execute the test mode.

In the test mode, the control unit 10 may execute stoppage priority acquisition processing for acquiring the stoppage priority indicating the order of stopping the nodes, node stopping processing for sequentially stopping the nodes following the acquired stoppage priority, and shutdown time display processing for displaying, for each node, the period from when stopping was instructed until when stopping completion is reported, as the shutdown time.

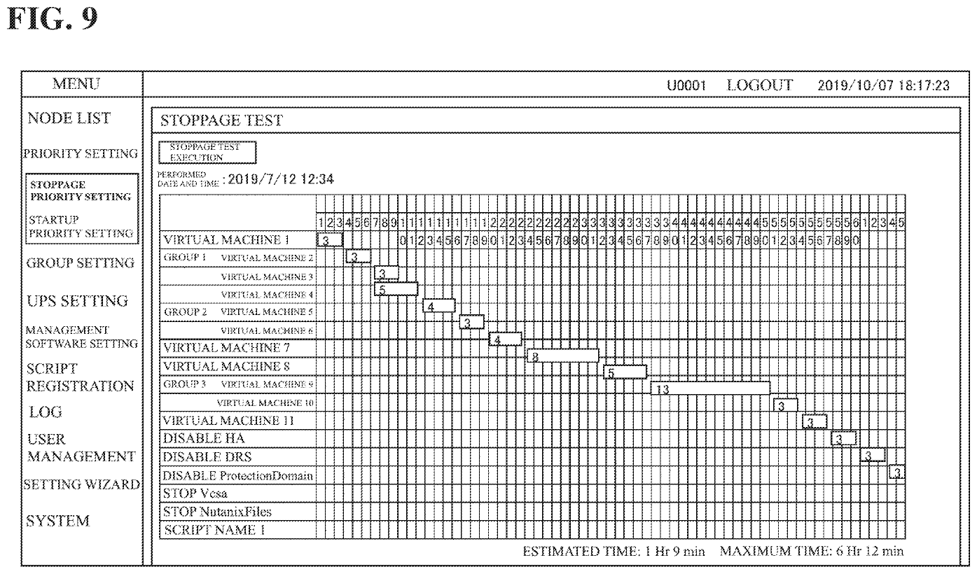

FIG. 9 is a diagram illustrating a screen for displaying the shutdown time and the like of each virtual machine 14 in a stoppage test according to the present embodiment.

The server 1 may further include a controller unit (display control unit) 125 that generates screen data for displaying the shutdown time of each virtual machine 14 in the test mode.

As shown in FIG. 9, the screen data may further include an estimated time (accumulated time) of the shutdown time of each virtual machine 14, an item indicating whether or not the shutdown of each virtual machine 14 is successful, and a maximum time (time limit of the accumulated time).

The estimated time may be a sum of the shutdown times estimated from the period from when stopping was instructed to each virtual machine 14 until when stopping completion of the virtual machine 14 is reported, which is obtained as a result of the server 1 executing the test mode. The maximum time may be the period for which the battery 75 can supply power in the backup operation. If the estimated time less than or equal to the maximum time, it can be considered that there is no problem because the shutdown of all of the virtual machines 14 can be ended in a period for which the battery 75 can supply power.

When the shutdown of a virtual machine 14 is normally ended, the display control unit may generate screen data including a black band corresponding to the virtual machine 14, for example. If the shutdown of a virtual machine 14 is abnormally ended, the display control unit may generate the screen data including a red band corresponding to the virtual machine 14, for example.

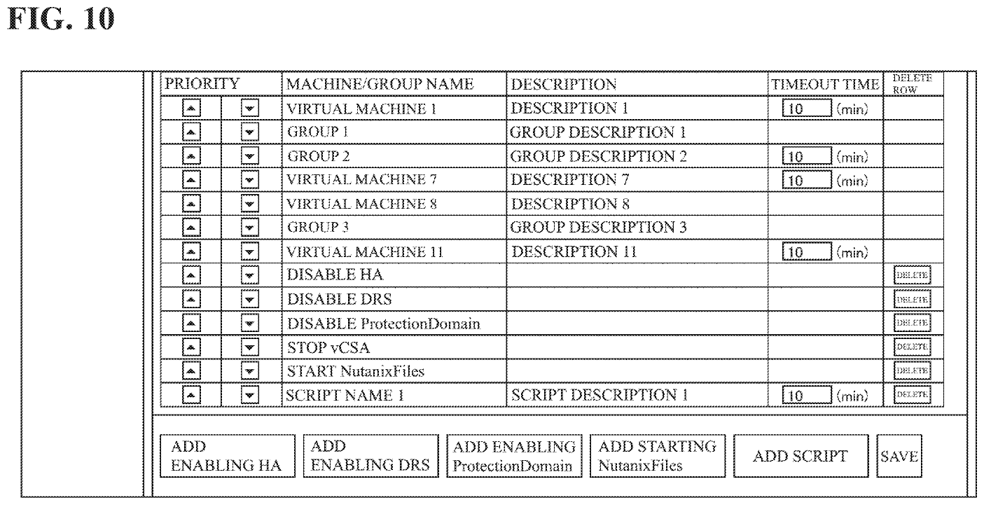

FIG. 10 is a diagram illustrating a screen for setting a timeout time of each node according to the present embodiment. As shown in FIG. 10, in the setting screen of the timeout time, necessary nodes can be added and the timeout time can be set.

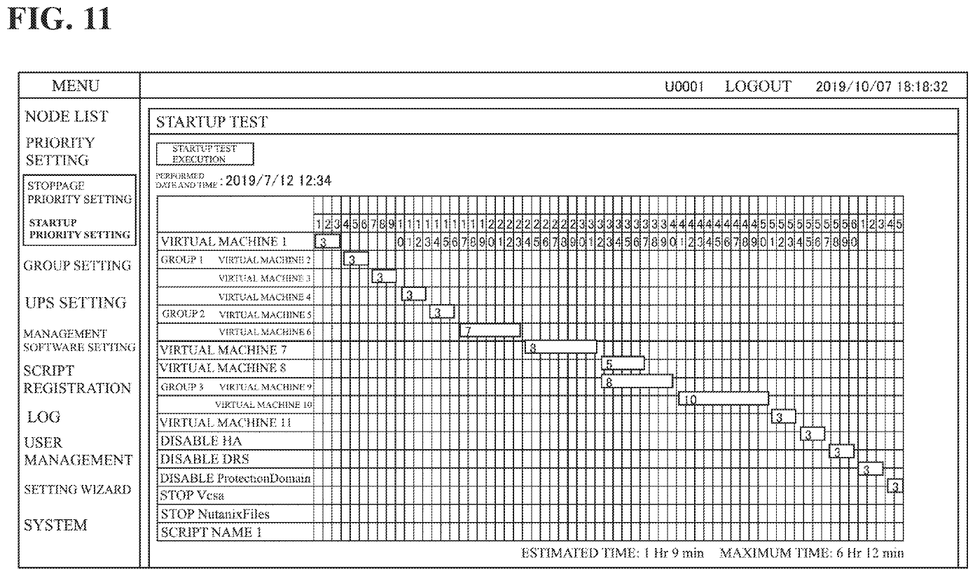

FIG. 11 is a diagram illustrating a screen for executing a startup test according to the present embodiment. As shown in FIG. 11, the execution screen of the startup test may show the startup order of the nodes, and the startup time of each node. The configuration may also be such that the server 1 performs the startup test of the plurality of virtual machines 14 (e.g., guest OSs) following a predetermined order. In this case, upon receiving an instruction to start the startup test that is given by a user operation, the control unit 10 of the server 1 may execute the startup test. The startup test may be performed in order for the user to confirm that each node normally starts up, after the test mode.

In the startup test, the control unit 10 may execute startup priority acquisition processing for acquiring the startup priority indicating the order of starting up the nodes, node startup processing for sequentially starting up the nodes following the acquired startup priority, and startup time display processing for displaying, for each node, the period from when startup was instructed until when startup completion is reported, as the startup time.

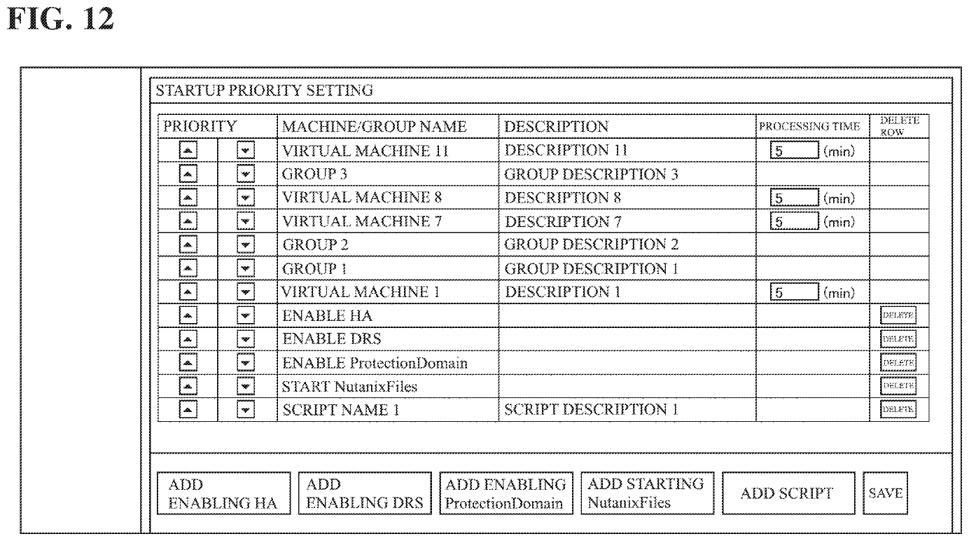

FIG. 12 is a diagram illustrating a screen for setting the startup priority according to the present embodiment. As shown in FIG. 12, in the setting screen of the startup priority, the priority of starting up the nodes can changed by a user by operating up and down buttons.

When the startup priority of the nodes is changed, the user may make an instruction to display a startup priority setting screen by operating the server 1. The control unit 10 of the server 1, upon receiving an instruction to display the startup priority setting screen, may display the startup priority setting screen in the display of the server 1. Also, when the startup priority is changed on the setting screen by the user operation, the control unit 10 may store the changed startup priority in a storage unit (not illustrated). Also, the control unit 10, upon receiving an instruction to start up the information processing system 100, may read out the startup priority from the storage unit, and may start up the nodes according to the startup priority.

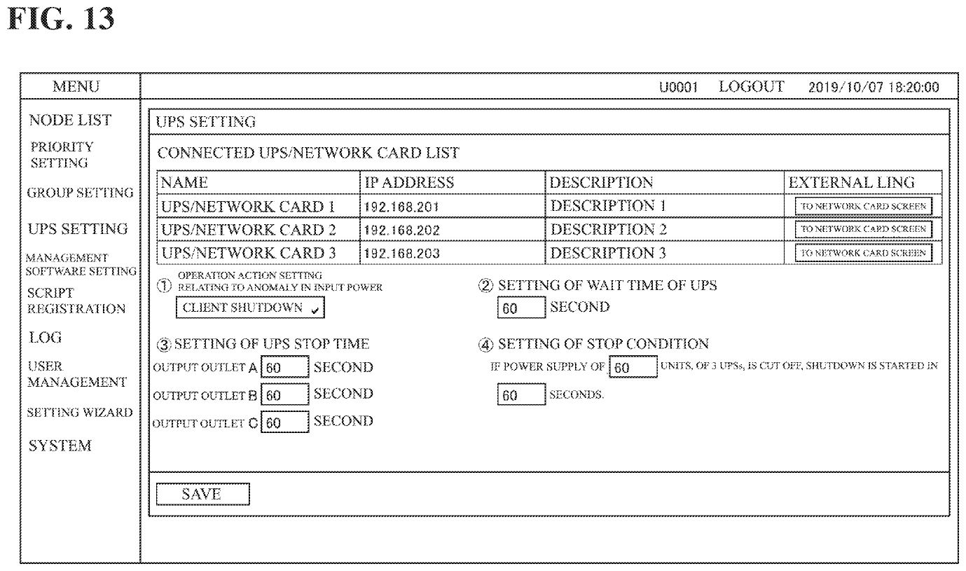

FIG. 13 is a diagram illustrating a setting screen regarding the UPS 2 according to the present embodiment. As shown in FIG. 13, in the setting screen of the UPS 2, an operation action regarding an anomaly in an input power supply, a wait time, a stop time, and a stop condition can be set.

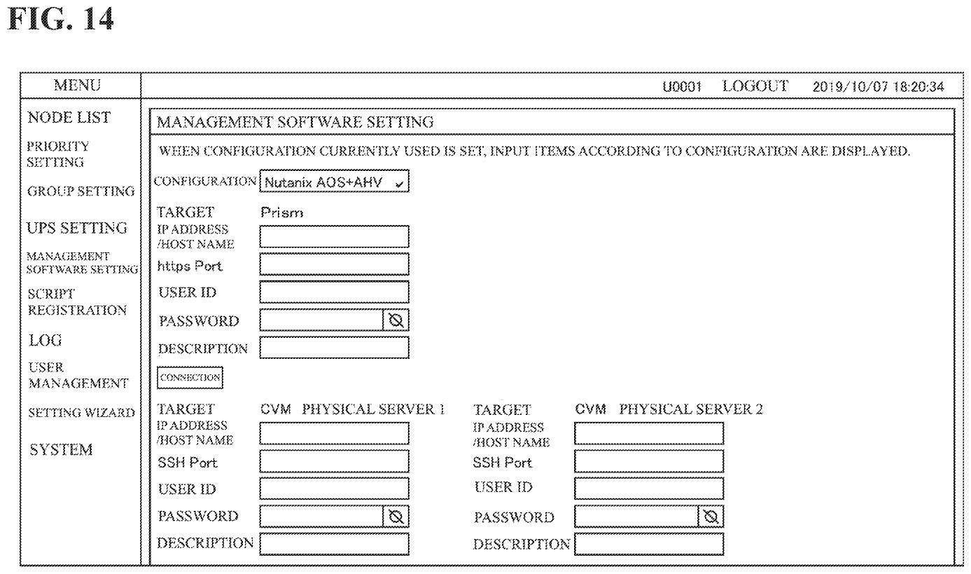

FIG. 14 is a diagram illustrating a setting screen regarding the management software 13 according to the present embodiment. As shown in FIG. 14, in the setting screen regarding the management software 13, Prism, which is one program of the management software 13, the IP address/host name of a server 1 to which the Prism is to be connected, the user ID, the password, and the like can be set.

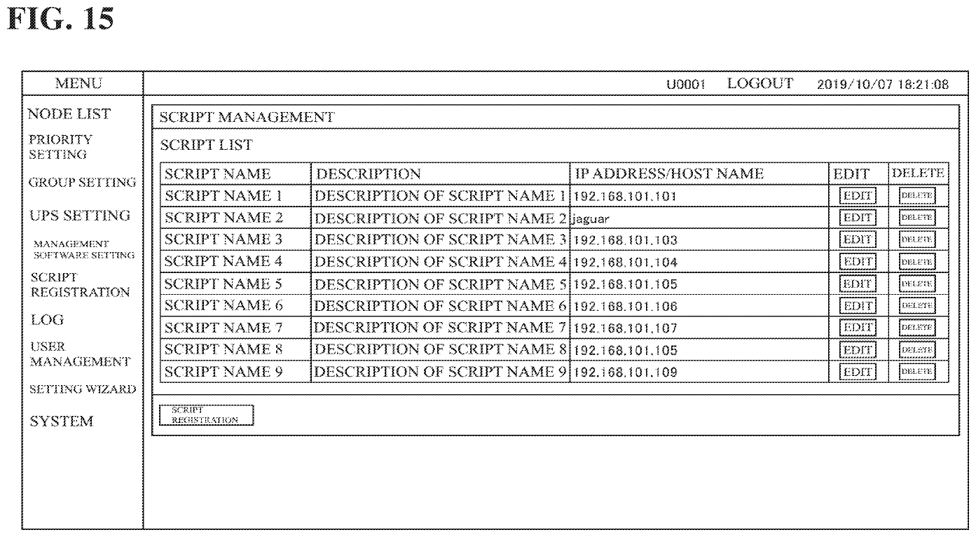

FIG. 15 is a diagram illustrating a script management screen according to the present embodiment. As shown in FIG. 15, in the script management screen, the IP addresses/host names of scripts to be executed in the network card 3 can be managed.

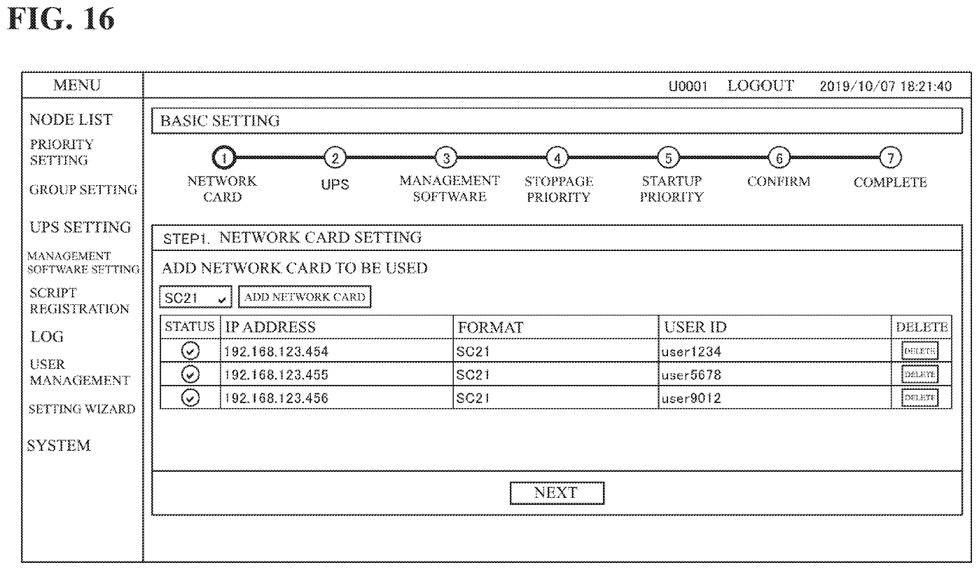

FIG. 16 is a diagram illustrating a basic setting screen according to the present embodiment. As shown in FIG. 16, in the basic setting screen, settings of the network cards 3, the UPSs 2, the management software 13, the stoppage priority and the startup priority of the nodes can be sequentially performed, and the settings can be confirmed.

### Exemplary Implementation by Software

The control blocks of the server 1 (specifically, the control unit 10) may be realized by logic circuits (hardware) formed in an integrated circuit (IC chip) or the like, or may be realized by software.

In the case of a software realization, the server 1 may include a computer that may execute commands in programs, which are software for implementing the functions. The computer may include at least one processor, and a computer-readable storage medium in which the programs are stored, for example. Also, one or more embodiments may be achieved by the processor reading out the programs from the storage medium and executing the programs, in the computer. A CPU (central processing unit) can be used as the processor, for example. A “non-transitory physical medium” such as a ROM (read only memory), tape, a disk, a card, a semiconductor memory, a programmable logic circuit, or the like can be used as the recording medium. Also, a RAM (random access memory) in which the programs are to be deployed may further be included. The programs may also be supplied to the computer through any transmission medium capable of transmitting the programs (a communication network, broadcast waves, or the like). An aspect of the present invention can be realized as data signals embedded in carrier waves so as to realize the electronic transmission of the programs.

### Annexes

In accordance with one or more embodiments a management method to be executed on at least one information processing device may comprise the at least one information processing device performing operations comprising: a first management operation of managing shutdown of a plurality of guest OSs that operate on the virtual OS; and a second management operation of shutting down the at least one information processing device when all of the plurality of guest OSs have been shut down by the first management operation. In the first management operation, when information indicating that shutdown of one of the plurality of guest OSs is completed is acquired, shutdown of a guest OS other than the one of the plurality of guest OSs is executed.

In accordance with one or more embodiments, an information processing system may comprise an information processing device, an uninterruptible power supply device, and a control device, the information processing device comprising a control unit. The control unit may be configured with instructions to perform operations comprising: operation as a first management unit configured to manage shutdown of a plurality of guest OSs that operate on a virtual OS; and operation as a second management unit configured to shut down the information processing device when all of the plurality of guest OSs have been shut down by the first management unit. The control unit may be configured with the instructions such that operation as the first management unit comprises, upon acquiring information indicating that shutdown of one of the plurality of guest OSs is completed, executing shutdown of a guest OS other than the one of the plurality of guest OSs, the uninterruptible power supply device is connected to the information processing device, and the control device controls the information processing device and the uninterruptible power supply device.

The present invention is not intended to be limited to the embodiments described above, and various changes can be made within the scope defined by the claims. Embodiments achieved by appropriately combining the technical means disclosed in different embodiments also fall within the technical scope of the present invention.

1. An information processing device, comprising;
a control unit configured with instructions to perform operations comprising:
operation as a first management unit configured to manage shutdown of a plurality of guest Operating Systems (OSs) that operate on a virtual OS; and
operation as a second management unit configured to shut down the information processing device in response to all of the plurality of guest OSs having been shut down by the first management unit, wherein
the control unit is configured with the instructions such that operation as the first management unit comprises, upon acquiring information indicating that shutdown of one of the plurality of guest OSs is completed, executing shutdown of a guest OS other than the one of the plurality of guest OSs for which shutdown is completed.

2. The information processing device according to claim 1, wherein
the control unit is configured with the instructions to perform operations further comprising operation as a third management unit that monitors the statuses of the plurality of guest OSs and controls the plurality of guest OSs, and
the control unit is configured with the instructions such that operation as the first management unit further comprises:
acquiring status information of each of the plurality of guest OSs via the third management unit; and
executing shutdown of the plurality of guest OSs via the third management unit.

3. The information processing device according to claim 1, wherein the control unit is configured with the instructions such that operation as the second management unit comprises, in response to all of the plurality of guest OSs being shut down by the first management unit, shutting down the information processing device via a control device that controls the information processing device and an uninterruptible power supply device connected to the information processing device.

4. The information processing device according to claim 3, wherein the control unit is configured to perform operations in a test mode in which the plurality of guest OSs are shut down according to a predetermined order.

5. The information processing device according to claim 4, wherein the control unit is configured with the instructions to perform operations further comprising operation as a display control unit configured to generate screen data for displaying a shutdown time of each guest OS in the test mode.

6. The information processing device according to claim 5, wherein the screen data comprises:
an accumulated time comprising the shutdown time of each guest OS;
an indication whether or not each guest OS has been successfully shut down; and
a time limit of the accumulated time.

7. A non-transitory computer-readable storage medium storing a management program to be executed on a virtual Operating System (OS) to be executed on at least one information processing device, the management program causing the at least one information processing device to perform operations comprising:
a first management operation of managing shutdown of a plurality of guest OSs that operate on the virtual OS; and
a second management operation of shutting down the at least one information processing device when all of the plurality of guest OSs have been shut down by the first management operation,
wherein, in the first management operation, when information indicating that shutdown of one of the plurality of guest OSs is completed is acquired, shutdown of a guest OS other than the one of the plurality of guest OSs is executed.

8. An information processing system that comprises a plurality of information processing devices, wherein
each of the plurality of information processing devices comprises a control unit,
the control unit of at least one information processing device is configured with instructions to perform operations comprising:
operation as a first management unit configured to manage shutdown of a plurality of guest OSs that operates on a virtual OS; and
operation as a second management unit configured to shut down the information processing devices when all of the plurality of guest OSs have been shut down by the first management unit, and
the control unit is configured with the instructions such that operation as the first management unit comprises, upon acquiring information indicating that shutdown of one of the plurality of guest OSs is completed, executing shutdown of a guest OS other than the one guest OS.
